(19) United States
(12) Patent Application Publication
(10) Pub. No.: US 2017/0109708 A1
(43) Pub. Date: Apr. 20, 2017

(54) PRODUCTIVITY THROUGH AUTOMATED WORK BALANCING

(71) Applicant: INTERNATIONAL BUSINESS MACHINES CORPORATION, Armonk, NY (US)

(72) Inventor: Satish K. Rao, Austin, TX (US)

(21) Appl. No.: 15/054,771

(22) Filed: Feb. 26, 2016

Related U.S. Application Data
(63) Continuation of application No. 14/886,479, filed on Oct. 19, 2015.

(51) Int. Cl. G06Q 10/10

(52) U.S. Cl. CPC G06Q 10/1095

(57) ABSTRACT

Methods and systems for scheduling include comparing a time commitment for a scheduling request, belonging to a scheduling category, to a difference between an invitee's existing time commitments for the scheduling category and a maximum time limit for the scheduling category. The scheduling request is entered if a sum of the time commitment for the scheduling request and the invitee's existing time commitments for the scheduling category falls below the maximum time limit. The scheduling request is entered if the scheduling request matches one or more override rules.

### BACKGROUND

Technical Field

The present invention relates to workload balancing and, more particularly, to meeting scheduling.

Description of the Related Art

In many large companies, a significant amount of employee time is spent in meetings, leaving little time for actual work during the day. As a result, many workers end up working after hours or over the weekends to complete their tasks. The requester of the meeting may not be aware of already-committed workloads for people being invited to attend the meetings, which may be especially problematic for workers who are expected to bill a certain number of billable hours per week.

This reflects a modern-day tragedy of the commons, referring to an economic theory in which individuals, acting independently and rationally according to each one's self-interest, behaves contrary to the whole group's long-term best interests by depleting some common resource. In this case, the common resource is time, and an overabundance of meetings cuts sharply into the amount of man-hours available to the company for productive work.

Existing solutions to this problem include individuals blocking out a set number of hours on their calendar for meetings. However, this may decrease the overall productivity of teams for the benefit of individual productivity if it makes the person inaccessible. This can be a particularly difficult problem in globally distributed teams. Another option is for an individual to decline the meeting invitation, which may make the individual appear rude to co-workers and management.

### SUMMARY

A method for scheduling includes comparing a time commitment for a scheduling request, belonging to a scheduling category, to a difference between an invitee's existing time commitments for the scheduling category and a maximum time limit for the scheduling category. The scheduling request is entered if a sum of the time commitment for the scheduling request and the invitee's existing time commitments for the scheduling category falls below the maximum time limit. The scheduling request is entered if the scheduling request matches one or more override rules.

A method for scheduling includes comparing a time commitment for a scheduling request to a difference between an invitee's existing time commitments for a scheduling category that includes the scheduling request and a maximum time limit for the scheduling category. The scheduling request is entered if a sum of the time commitment for the scheduling request and the invitee's existing time commitments for the scheduling category falls below the maximum time limit. The scheduling request is entered if the scheduling request matches one or more override rules. The override rules include a rule that enters scheduling requests that come from external users that are external to the invitee's organization, a rule that enters scheduling requests that come from a member of a group shared by the invitee, a rule that enters scheduling requests that come from an executive or other person of authority in the invitee's organization, and a rule that enters scheduling requests that are marked as being urgent.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a block/flow diagram of a scheduling method in accordance with the present principles;

FIG. 2 is a block diagram of a scheduling system in accordance with the present principles; and

FIG. 3 is a block/flow diagram of a scheduling method in accordance with the present principles.

### DETAILED DESCRIPTION

Embodiments of the present invention allow invitees (alternatively called “users” herein) to set a limit for the number of hours per week to be allocated to meetings. The user can further configure the settings to override the limit when the meeting request is from important stakeholders, such as clients, or when meeting requests are related to billable work. In this manner, the user can increase the number of hours available for productive work, while still being responsive to meeting requests that have a high importance.

The present embodiments may be integrated with existing scheduling software, for example through the use of a plugin. It is particularly contemplated that the present embodiments may be implemented as a software module using a portable programming language. The present embodiments allow a user to improve their productivity and work-life balance by setting a limit on meetings that are not directly related to currently committed deliverables. This process is performed automatically, according to pre-set priorities, allowing a user to filter meeting requests automatically. When a meeting request passes through the filter, either because there are sufficient unallocated hours for it, or because it matches one or more override criteria, the user is given the option of accepting or declining the request manually.

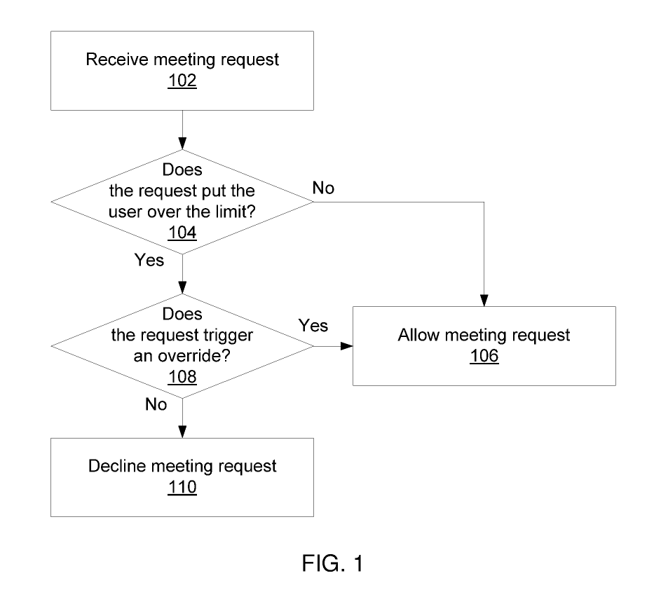

Referring now to FIG. 1, a method for scheduling a meeting is shown. Block 102 receives a meeting request for the user. The request may come from a co-worker, a boss, any other third party, or even from the user themselves. Block 104 determines whether the request would put the user over their limit for meetings. The limit in this case may represent a set number of hours allocated for meetings in a week, a percentage of the week to be so allocated, a set number of meetings, or some other threshold meant to place a limit on how much time the user spends in meetings relative to more directly productive types of work. It should be noted that the meeting request may also be categorized according to a meeting type, and so there may be multiple limits pertaining to different meeting types. For example, meetings with clients may have more time allotted to them in a week than meetings with co-workers. If the request does not put the user over their limit, block 106 enters the meeting request and presents the request to the user for a decision as to whether to accept or decline the request.

Otherwise, block 108 determines whether the request triggers an override. The overrides are a set of user-configurable rules that determine whether a request will be allowed despite running over a user's limit. The overrides thereby provide a way to prioritize important meeting requests, so that they do not get ignored accidentally. The overrides may include one or more of the following rules:

1. Internal vs. external rule. This rule determines whether the meeting requester is internal or external to the company. One way of accomplishing this would be to compare a domain name of the requester to a list of approved internal addresses. External requests are more likely to be from clients, for example, and therefore more likely to be high-priority requests. Implementing this rule would therefore override the limit to allow the user to accept or reject the request.

2. Group rule. The user can create specific groups of users that will have override capability. In one example, these groups might represent teams or committees that the user belongs to, where meeting requests from such people are more likely to be particularly relevant to the user or to be directly related to the user's productivity. In this case, members of the same team would then be able to issue meeting requests that exceed the user's limits.

3. Executive rule. If the meeting request is from an executive of the user's company, the invitee's supervisor, or other person of authority, then an override may be triggered so that the user may personally review requests they will be held accountable for.

4. Urgency rule. If the meeting request is marked urgent, then an override may be triggered. An urgency rule may furthermore be configured with exceptions for particular parties in the event that the user receives many invitations from some party that are needlessly marked as being urgent.

5. Customizable rules. Users may have the ability to develop override rules of their own based on a wide variety of conditions or combinations of conditions. For example, the user might select one or more customizable conditions (e.g., a source country for a request) and set parameters that determine when the condition is triggered (e.g., allow overrides for meeting requests from China). These conditions may also include temporal conditions, relating to a time of day, week, or month that the request is for, geographic conditions (e.g., where the meeting is to be located), conditions relating to the type of meeting (e.g., in-person versus teleconference), and so on. Through a combination of such conditions, the user has substantial flexibility in controlling the portion of their time spent in meetings.

If the request triggers an override, block 106 enters the meeting request to go to the user for personal review. If not, block 110 declines the meeting request using, for example, a standard template or form message. The user may have the option of personalizing the automated message for block 110 and may use more than one template in accordance with one or more criteria.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

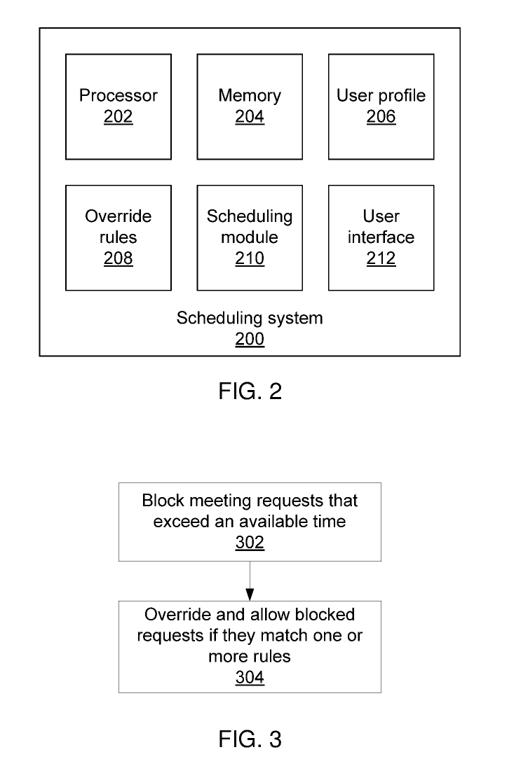

Referring now to FIG. 2, a scheduling system 200 is shown. The system 200 includes a processor 202 and memory 204. The processor 202 is a hardware processor, and it is contemplated that one or more software modules may be stored in memory 204 and may be executed using the processor 202. Alternatively, the modules may be implemented as hardware in the form of, e.g., an application-specific integrated chip or a field-programmable gate array. The memory 204 stores a user profile 206 which includes the user's scheduling information. The scheduling information may include, for example, a calendar that represents existing commitments as well as a user-settable time limit for meetings in one or more categories. The memory 204 also includes one or more override rules 208 that provide conditions under which a scheduling request may override a user's time limit for meetings.

A scheduling module 210 then accepts new scheduling requests and determines whether to allow them to pass to the user for review or to deny them based on the user's time limit, the user's existing commitments, and the override rules 208. The scheduling module 210 may be, for example, a plugin to an existing mail client or groupware application that provides the above functionality on an existing calendar system, or alternatively the scheduling module 210 can be a standalone application configured to manage users' calendars. The scheduling module 210 determines whether or not to present a given request to the user. If the scheduling module 210 determines that the request should be declined, it automatically declines the request in accordance with settings stored in the user profile 206. A user interface 212 allows the user to make changes to the user profile 206 and override rules 208 and furthermore allows the user to make direct decisions as to whether to accept or decline a scheduling request that has made it through the scheduling module 210. The user interface 212 may be local to the scheduling system 200 or may be on a separate device that accesses the scheduling system through a network.

Referring now to FIG. 3, a block/flow diagram of an overview of the present principles is provided. Block 302 blocks an incoming meeting request if it exceeds a number of hours that a user has allotted for meetings (or a number of such hours remaining). Block 304 then overrides the block if the request meets one or more rules as described above.

Having described preferred embodiments of improving productivity through automated work balancing (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for scheduling, comprising:
comparing a time commitment for a scheduling request, belonging to a scheduling category, to a difference between an invitee's existing time commitments for the scheduling category and a maximum time limit for the scheduling category;
entering the scheduling request if a sum of the time commitment for the scheduling request and the invitee's existing time commitments for the scheduling category falls below the maximum time limit; and
entering the scheduling request if the scheduling request matches one or more override rules.

2. The method of claim 1, wherein the one or more override rules comprise a rule that enters scheduling requests that come from external users that are external to the invitee's organization.

3. The method of claim 2, wherein the rule that enters scheduling requests that come from external users comprises a list of internal users, wherein external users do not match the list.

4. The method of claim 1, wherein the one or more override rules comprise a rule that enters scheduling requests that come from a member of a group shared by the invitee.

5. The method of claim 4, wherein the rule that enters scheduling requests that come from a member of a group shared by the invitee comprises a list of groups that the invitee belongs to.

6. The method of claim 1, wherein the one or more override rules comprises a rule that enters scheduling requests that come from an executive or other person of authority in the invitee's organization.

7. The method of claim 6, wherein the rule that enters scheduling requests that come from an executive or other person of authority comprises a list of individuals that have override authority.

8. The method of claim 1, wherein the one or more override rules comprises a rule that enters scheduling requests that are marked as being urgent.

9. The method of claim 1, wherein the one or more override rules comprises a user-defined rule that includes a plurality of conditions.

10. A computer readable storage medium comprising a computer readable program for scheduling, wherein the computer readable program when executed on a computer causes the computer to perform the steps of claim 1.

11. A method for scheduling, comprising:
comparing a time commitment for a scheduling request to a difference between an invitee's existing time commitments for a scheduling category that includes the scheduling request and a maximum time limit for the scheduling category;
entering the scheduling request if a sum of the time commitment for the scheduling request and the invitee's existing time commitments for the scheduling category falls below the maximum time limit; and
entering the scheduling request if the scheduling request matches one or more override rules, wherein the override rules comprise a rule that enters scheduling requests that come from external users that are external to the invitee's organization, a rule that enters scheduling requests that come from a member of a group shared by the invitee, a rule that enters scheduling requests that come from an executive or other person of authority in the invitee's organization, and a rule that enters scheduling requests that are marked as being urgent.
